(19) United States
(12) Patent Application Publication
(10) Pub. No.: US 2014/0380492 A1
(43) Pub. Date: Dec. 25, 2014

(54) METHOD FOR CONTROLLING CONTENTS SECURITY AND ELECTRONIC DEVICE THEREOF

(71) Applicant: Samsung Electronics Co., Ltd., Suwon-si (KR)

(72) Inventor: Byung-Jai IM, Suwon-si (KR)

(73) Assignee: Samsung Electronics Co., Ltd., Suwon-si (KR)

(21) Appl. No.: 14/290,371

(22) Filed: May 29, 2014

(30) Foreign Application Priority Data
Jun. 21, 2013 (KR) 10-2013-0071826

(51) Int. Cl. G06F 21/60

(52) U.S. Cl. CPC G06F 21/60
USPC 726/26

(57) ABSTRACT

A method and an apparatus for controlling contents security in an electronic device are provided. The method includes determining at least one region for security setting in contents, and setting security to the region for security setting.

### CROSS-REFERENCE TO RELATED APPLICATION

This application claims the benefit under 35 U.S.C. §119(a) of a Korean patent application filed on Jun. 21, 2013 in the Korean Intellectual Property Office and assigned Serial number 10-2013-0071826, the entire disclosure of which is hereby incorporated by reference.

### TECHNICAL FIELD

The present disclosure relates to a method and apparatus for setting or canceling security from a partial region of contents in an electronic device.

### BACKGROUND

Electronic devices are becoming necessities of modern people due to the ease of portability and increasing abilities, and are evolving into multimedia devices providing various services such as a voice and video phone function, an information input/output function, and a data transmission/reception function.

Recently, increased awareness of a need for security of personal information and contents (e.g., an image, a messenger message) stored in electronic devices is emerging. An electronic device user can set security to personal information and other contents requiring security by using a password. For example, as illustrated in FIG. 1A, after writing a memo in an edit mode 103 of a memo application program 101, the electronic device user can select a “password setting” lock icon 105 to set a password to the memo. After that, as illustrated in FIG. 1B, an electronic device can display a memo 113 to which a password is set, in a memo list 111. At this time, the electronic device may display a lock shaped icon 115 on the memo 113 so as to indicate that the password is set to the memo 113. Next, if a selection of the memo 113 is sensed, as illustrated in FIG. 1C, the electronic device can determine whether a password entered through a “password confirmation” menu 121 matches with the password previously set to the memo 113 and, if so, display the content of the memo 113.

In this case, there is an inconvenience that, even when the user confirms insignificant content among the content of the memo 113 as illustrated in FIG. 1A, he/she must enter the password to open the memo each time. Also, there is an additional drawback that a probability of password leakage increases, because the password is entered each time.

According to this, an interface for setting security to a partial region of contents in an electronic device is needed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages below. Accordingly, an aspect of the present disclosure is to provide an apparatus and method for setting security of contents in an electronic device.

Another aspect of the present disclosure is to provide an apparatus and method for setting security of a partial region of contents in an electronic device.

A further aspect of the present disclosure is to provide an apparatus and method for setting a password of a partial region of contents in an electronic device.

Another aspect of the present disclosure is to provide an apparatus and method for setting a pattern of a partial region of contents in an electronic device.

Another aspect of the present disclosure is to provide an apparatus and method for separating and storing original contents and a secured region of the contents separately in an electronic device.

Another aspect of the present disclosure is to provide an apparatus and method for displaying contents including a secured region in an electronic device.

Another aspect of the present disclosure is to provide an apparatus and method for displaying contents including a secured region by a preview in an electronic device.

The above aspects are addressed by providing a method for controlling contents security and an electronic device thereof.

In accordance with an aspect of the present disclosure, a method for controlling contents security in an electronic device is provided. The method includes determining at least one region for security setting in contents, and setting security to the region for security setting. The contents may include at least one of a document, a memo, an image, an instant message, an electronic mail (e-mail), a Short Message Service (SMS) message, and a Multimedia Message Service (MMS) message.

In accordance with another aspect of the present disclosure, a method for controlling contents security in an electronic device is provided. The method includes displaying contents including at least one secured region, if a selection of the secured region is detected, determining a security cancelation or non-cancelation of the secured region, and if the security of the secured region is canceled, displaying original content of the contents for the canceled secured region.

In accordance with another aspect of the present disclosure, an electronic device including at least one memory and at least one processor is provided. The at least one memory is configured to store data and instructions. The at least one processor is configured to determine at least one region for security setting in contents, and to set security to the region for security setting. The contents may include at least one of a document, a memo, an image, an instant message, an e-mail, an SMS message, and an MMS message.

In accordance with yet another aspect of the present disclosure, an electronic device including at least one memory and at least one processor is provided. The at least one memory is configured to store data and instructions. The at least one processor is configured to control to display contents including at least one secured region and, if a selection of the secured region is sensed, to determine a security cancelation or non-cancelation of the secured region and, if the security of the secured region is canceled, to display original content of the contents for the canceled secured region.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A, 1B, and 1C are screen configurations of setting security to contents in an electronic device according to the related art of the present disclosure;

FIG. 2 is a block diagram illustrating a construction of an electronic device according to an embodiment of the present disclosure;

FIG. 3 is a detailed block diagram illustrating a construction of a processor according to an embodiment of the present disclosure;

FIG. 4 is a flowchart illustrating a procedure for setting security to a partial region of contents in an electronic device according to an embodiment of the present disclosure;

FIG. 5 is a flowchart illustrating a procedure for setting security to a partial region of contents using a password in an electronic device according to another embodiment of the present disclosure;

FIG. 6 is a flowchart illustrating a procedure for setting security to a partial region of contents using a pattern in an electronic device according to a further embodiment of the present disclosure;

FIGS. 7A, 7B, 7C, 7D, 7E, 7F, and 7G illustrate screen configurations of setting security to a partial region of contents in an electronic device according to an embodiment of the present disclosure;

FIG. 8 is a flowchart illustrating a procedure for providing contents for which security is set to a partial region of the contents by a password in an electronic device according to another embodiment of the present disclosure;

FIG. 9 is a flowchart illustrating a procedure for providing contents for which security is set to a partial region of the contents by a pattern in an electronic device according to a still another embodiment of the present disclosure; and

FIGS. 10A, 10B, 10C, 10D, 10E, and 10F illustrate screen configurations of providing contents for which security is set to a partial region of the contents in an electronic device according to an embodiment of the present disclosure.

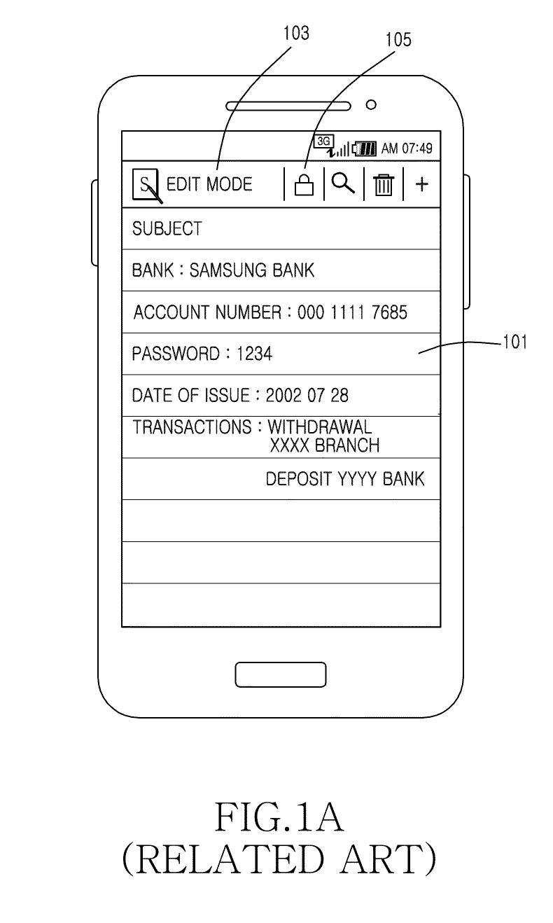

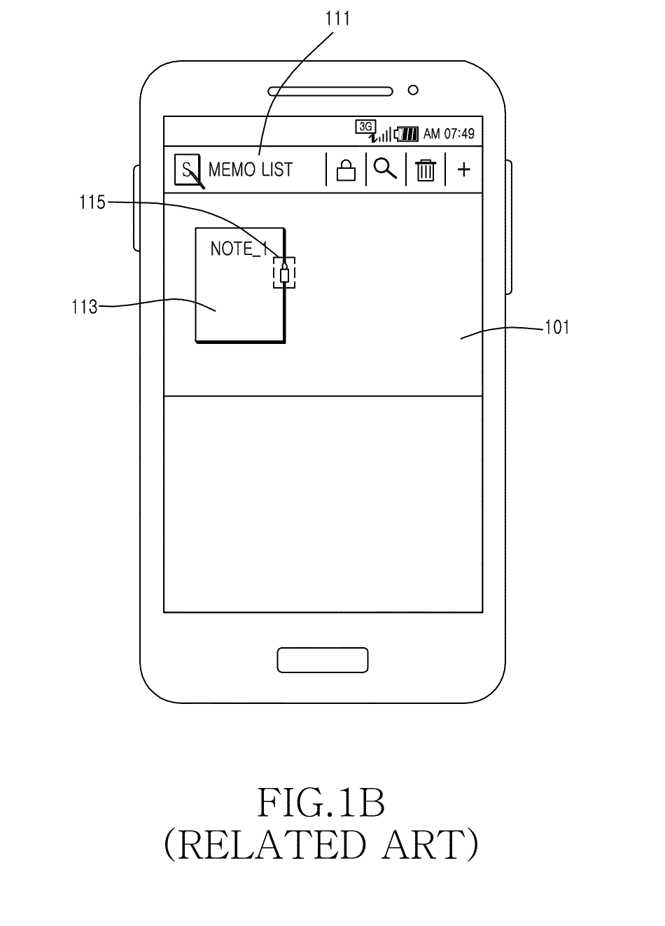

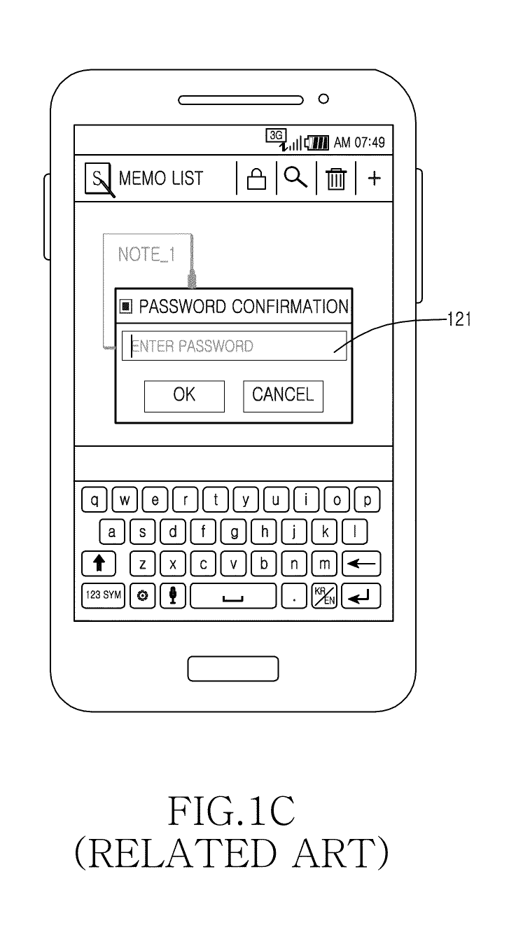

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure relates to a technology for setting security of a partial region of contents in an electronic device.

In the following description, the electronic device can include a mobile communication terminal, a Personal Digital Assistant (PDA), a laptop computer, a smart phone, a netbook, a television, a Mobile Internet Device (MID), an Ultra Mobile Personal Computer (UMPC), a tablet PC, a navigator, a digital watch, a refrigerator, and a Motion Picture Experts Group (MPEG)-2 Audio Layer-III (MP3) player.

In the following description, contents include at least one of a document, a memo, an image, a messenger message, an electronic mail (e-mail), a Short Message Service (SMS) message, and a Multimedia Message Service (MMS) message. Also, in the following description, the memo is described as an example of the contents, but this does not intend to limit the scope and spirit of the present disclosure.

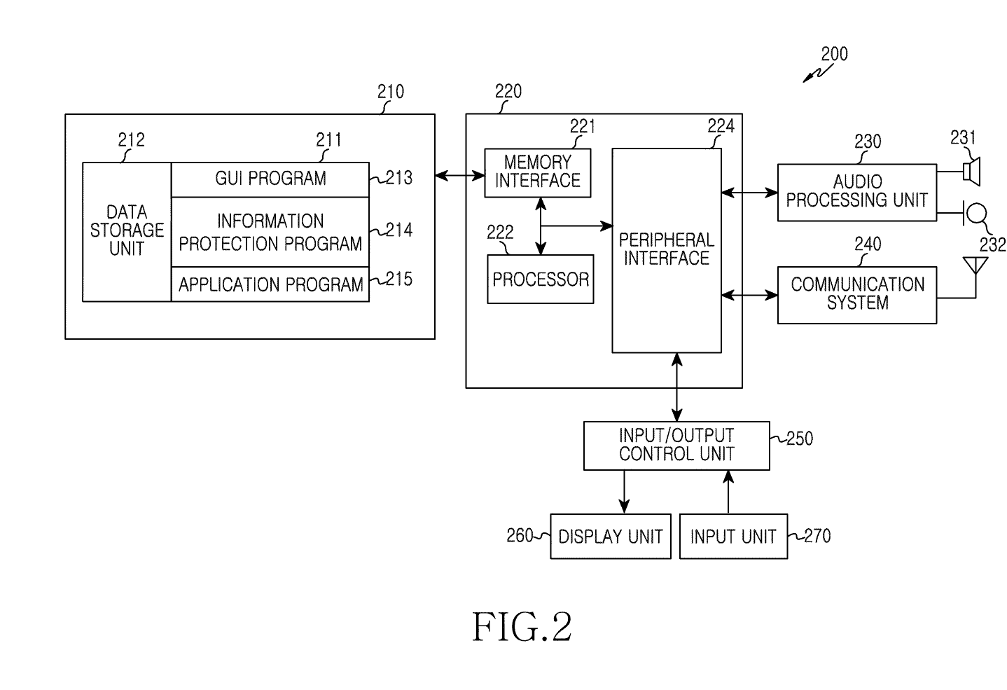

FIG. 2 is a block diagram illustrating a construction of an electronic device according to an embodiment of the present disclosure.

Referring to FIG. 2, the electronic device 200 can include a memory 210, a processor unit 220, an audio processing unit 230, a communication system 240, an input/output control unit 250, a display unit 260, and an input unit 270. Here, each constituent unit included in the electronic device 200 may exist in plural. Further, described units of the electronic device 200 may be implemented as discrete units, or as one or more units such as an integrated circuit combining functions of one or more of the described units.

Each constituent element is described as follows.

The memory 210 includes a program storage unit 211 storing a program for controlling an operation of the electronic device 200, and a data storage unit 212 storing data generated during program execution. For example, the memory 210 can include a secured region set to contents provided from an information protection program 214. At this time, the memory 210 can include original contents and a secured region of the contents separately, for example, as separate layers. Also, the memory 210 may include at least one of a password and a pattern set to the secured region.

The program storage unit 211 may include a Graphical User Interface (GUI) program 213, the information protection program 214, and at least one application program 215. Here, the program included in the program storage unit 211, which is a set of instructions, may be expressed as an instruction set.

The GUI program 213 may include at least one software constituent element configured to provide a graphic user interface to the display unit 260. For example, the GUI program 213 controls to display on the display unit 260 a region for security setting set to a partial region of contents by the information protection program 214. For another example, the GUI program 213 may control to display on the display unit 260 a password setting menu for setting security to a region for security setting by the information protection program 214. For further example, the GUI program 213 may control to display on the display unit 260 a pattern setting menu for setting security to the region for security setting by the information protection program 214.

The information protection program 214 may include at least one software constituent element configured to control to set security of a partial region of contents. For example, when a security setting event occurs, the information protection program 214 confirms a region for security setting in contents. At this time, the information protection program 214 determines the at least one region for security setting using at least one of a diagram, a picture, an icon, a photo, an image, and a block designation for the partial region of the contents. At this time, the information protection program 214 may generate at least one second layer for displaying the at least one region for security setting, apart from a first layer for displaying the original content of the contents. Also, the information protection program 214 may input characters on the region for security setting, or locate at least one of a diagram, a picture, an icon, a photo, and an image to be superimposed on the region for security setting. Next, the information protection program 214 controls to display a password setting menu for setting security to the region for security setting, and sets a password for setting the security to the region for security setting considering at least one of a character, a numeral, and a symbol entered through the password setting menu. Also, the information protection program 214 may control to display a pattern setting menu for setting security to the region for security setting, and set a pattern for setting the security to the region for security setting using a starting point and end point of a pattern that is drawn through the pattern setting menu. Additionally, the information protection program 214 may control to store information about the secured region and the security set to the secured region.

Also, the information protection program 214 may include at least one software constituent element configured to control to provide contents including a secured region. For example, the information protection program 214 controls to display contents including at least one secured region and, when a selection of the secured region is detected, the information protection program 214 determines the security cancelation or non-cancelation of the secured region. At this time, the information protection program 214 can control to display a password confirmation menu for determining the security cancelation or non-cancelation of the secured region, and determine matching or non-matching with a password previously set to the secured region considering at least one of a character, a numeral and a symbol entered through the password confirmation menu. Also, the information protection program 214 may control to display a pattern confirmation menu for determining the security cancelation or non-cancelation of the secured region, and determine matching or non-matching with a pattern previously set to the secured region considering a starting point and end point of a pattern that is drawn through the pattern confirmation menu. Next, if the security of the secured region is canceled, the information protection program 214 controls to display the original content of the contents for the canceled secured region.

The application program 215 includes a software constituent element for at least one application program installed in the electronic device 200.

The processor unit 220 can include a memory interface 221, at least one processor 222, and a peripheral interface 224. Here, the memory interface 221, the at least one processor 222, and the peripheral interface 224, which are included in the processor unit 220, can be integrated as at least one integrated circuit or be realized as separate constituent elements.

The memory interface 221 controls the access of a constituent element such as the processor 222 or the peripheral interface 224 to the memory 210.

The peripheral interface 224 controls the connection of the processor 222 and the memory interface 221 with an input output peripheral device of the electronic device 200.

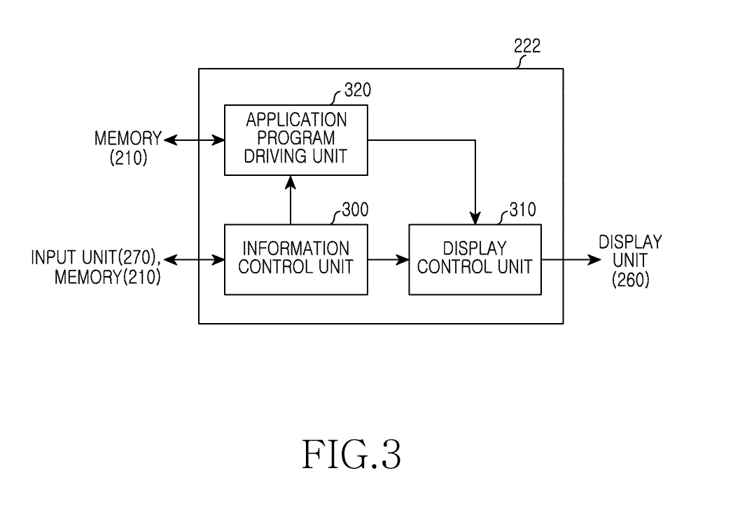

The processor 222 controls the electronic device 200 to provide various services using at least one software program. In an embodiment, the processor 222 executes at least one program stored in the memory 210 and controls to provide a service according to the executed program. To execute the information protection program 214 to control security setting to contents, the processor 222 can be constructed as illustrated in FIG. 3.

The audio processor 230 provides an audio interface between a user and the electronic device 200 through a speaker 231 and a microphone 232.

The communication system 240 includes at least one software constituent element for performing a communication function for voice communication and data communication. In an embodiment, the communication system 240 may be distinguished into a plurality of communication sub modules supporting different communication networks. For example, the communication network can include, though is not limited to, a Global System for Mobile Communication (GSM) network, an Enhanced Data GSM Environment (EDGE) network, a Code Division Multiple Access (CDMA) network, a Wireless-Code Division Multiple Access (W-CDMA) network, a Long Term Evolution (LTE) network, an Orthogonal Frequency Division Multiple Access (OFDMA) network, a Wireless Local Area Network (WLAN), a BLUETOOTH network, and a Near Field Communication (NFC) network.

The input/output control unit 250 provides an interface between an input output device including the display unit 260 and the input unit 270, and the peripheral interface 224.

The display unit 260 displays various visual outputs including status information of the electronic device 200, characters input by a user, a moving picture, and a still picture. For example, the display unit 260 displays information of an application program which is driven by the processor 222. For another example, the display unit 260 can display a region for security setting set to a partial region of contents provided from the information protection program 214 according to the control of the GUI program 213. For further example, the display unit 260 can display a password setting menu for setting security to the region for security setting provided from the information protection program 214 according to the control of the GUI program 213. For yet another example, the display unit 260 can display a pattern setting menu for setting security to the region for security setting provided from the information protection program 214 according to the control of the GUI program 213.

The input unit 270 provides input data generated by user's selection, to the processor unit 220 through the input/output control unit 250. In an embodiment, the input unit 270 can include a key pad including at least one hardware button, and a touch pad detecting touch information. For example, the input unit 270 provides the touch information detected through the touch pad to the processor 222 through the input/output control unit 250.

FIG. 3 is a detailed block diagram illustrating a construction of a processor according to an embodiment of the present disclosure.

Referring to FIG. 3, the processor 222 may include an information control unit 300, a display control unit 310, and an application program driving unit 320.

The information control unit 300 executes the information protection program 214 of the program storage unit 211 and controls to set security to a partial region of contents. For example, when a security setting event occurs, the information control unit 300 confirms a region for security setting in the contents. At this time, the information control unit 300 determines the at least one region for security setting using at least one of a diagram, a picture, an icon, a photo, an image, and a block designation for the partial region of the contents. At this time, the information control unit 300 may generate at least one second layer for displaying the at least one region for security setting, apart from a first layer for displaying the original content of the contents. Also, the information control unit 300 may input characters on the region for security setting, or locate at least one of a diagram, a picture, an icon, a photo, and an image to be superimposed on the region for security setting. Next, the information control unit 300 controls to display a password setting menu for setting security to the region for security setting, and sets a password for setting the security to the region for security setting considering at least one of a character, a numeral, and a symbol entered through the password setting menu. Also, the information control unit 300 may control to display a pattern setting menu for setting security to the region for security setting, and set a pattern for setting the security to the region for security setting using a starting point and end point of a pattern that is drawn through the pattern setting menu. Additionally, the information control unit 300 may control to store information about the secured region and the security set to the secured region.

Also, the information control unit 300 executes the information protection program 214 of the program storage unit 211 and controls to provide contents including a secured region. For example, the information control unit 300 controls to display contents including at least one secured region and, when a selection of the secured region is sensed, the information control unit 300 determines the security cancelation or non-cancelation of the secured region. At this time, the information control unit 300 can control to display a password confirmation menu for determining the security cancelation or non-cancelation of the secured region, and determine matching or non-matching with a password previously set to the secured region considering at least one of a character, a numeral, and a symbol entered through the password confirmation menu. Also, the information control unit 300 may control to display a pattern confirmation menu for determining the security cancelation or non-cancelation of the secured region, and determine matching or non-matching with a pattern previously set to the secured region considering a starting point and end point of a pattern that is drawn through the pattern confirmation menu. Next, if the security of the secured region is canceled, the information control unit 300 controls to display the original content of the contents for the canceled secured region.

The display control unit 310 executes the GUI program 213 of the program storage unit 211 and provides a graphic user interface to the display unit 260. For example, the display control unit 310 controls to display on the display unit 260 a region for security setting set to a partial region of contents by the information control unit 300. For another example, the display control unit 310 may control to display on the display unit 260 a password setting menu for setting security to the region for security setting by the information control unit 300. For further example, the display control unit 310 may control to display on the display unit 260 a pattern setting menu for setting security to the region for security setting by the information control unit 300.

In the aforementioned embodiment, the information control unit 300 of the electronic device executes the information protection program 214 to control security setting and security cancelation for contents.

In another embodiment, the electronic device may include a separate information protection module including the information protection program 214.

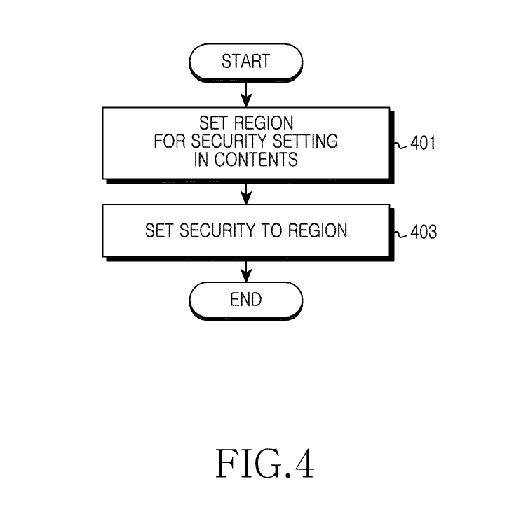

FIG. 4 is a flowchart illustrating a procedure for setting security of a partial region of contents in an electronic device according to an embodiment of the present disclosure.

Referring to FIG. 4, in operation 401, when a security setting event occurs, the electronic device confirms a region for security setting in contents. For example, the electronic device determines the at least one region for security setting using at least one of a diagram, a picture, an icon, a photo, an image, and a block designation for a partial region of the contents. At this time, the electronic device may generate at least one second layer for displaying the at least one region for security setting, apart from a first layer for displaying the original content of the contents. Also, the electronic device may input characters on the region for security setting, or locate at least one of a diagram, a picture, an icon, a photo, and an image to be superimposed on the region for security setting.

Next, in operation 403, the electronic device sets security to the region for security setting. For example, the electronic device displays a password setting menu for setting security to the region for security setting, and sets a password for setting the security to the region for security setting using at least one of a character, a numeral, and a symbol entered through the password setting menu. For another example, the electronic device may display a pattern setting menu for setting security to the region for security setting, and set a pattern for setting the security to the region for security setting using a starting point and end point of a pattern that is drawn through the pattern setting menu. Additionally, the electronic device may store information about the secured region and the security set to the secured region.

After that, the electronic device terminates the algorithm of the present disclosure.

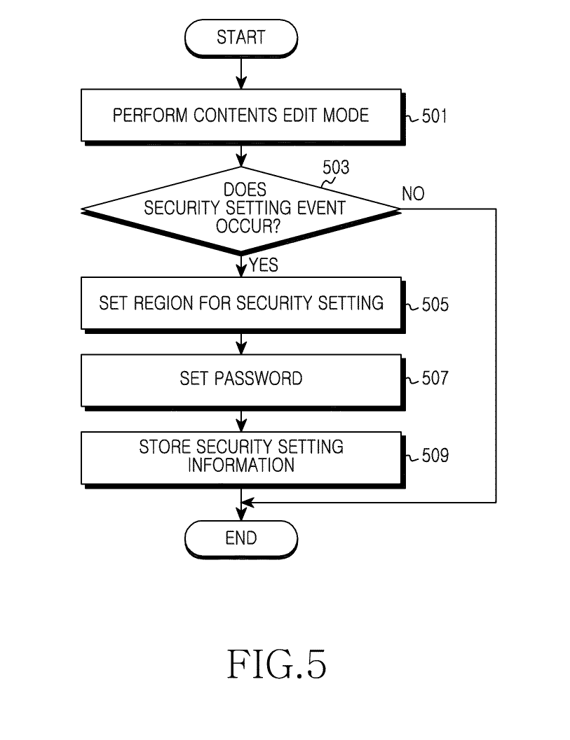

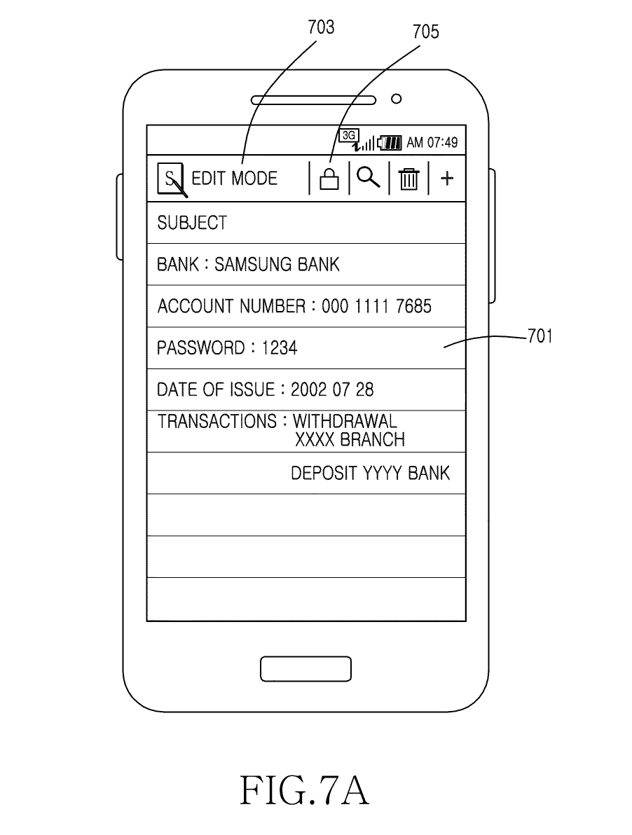

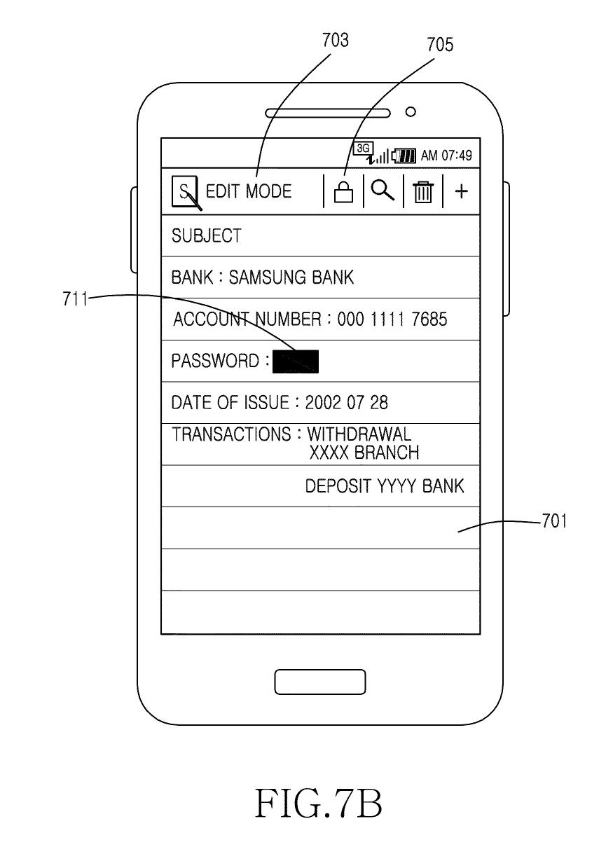

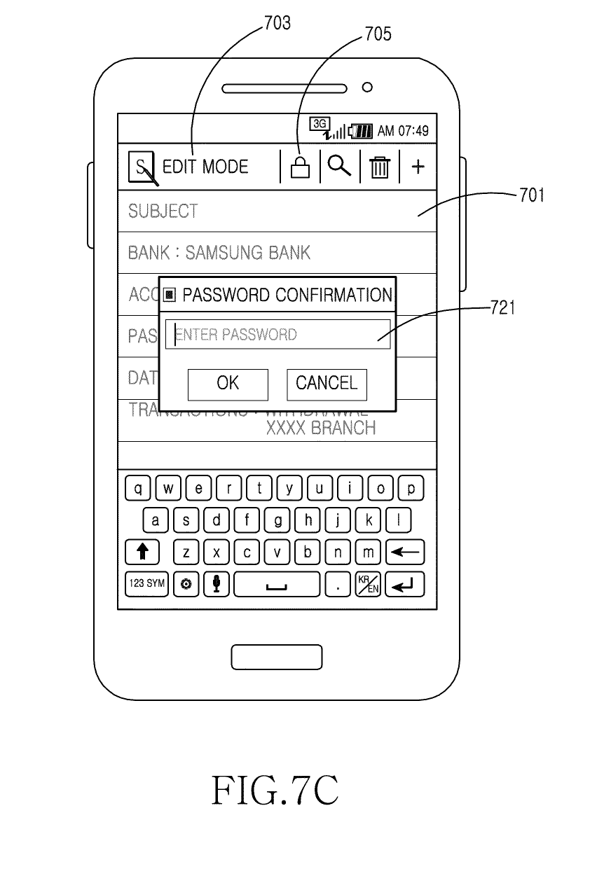

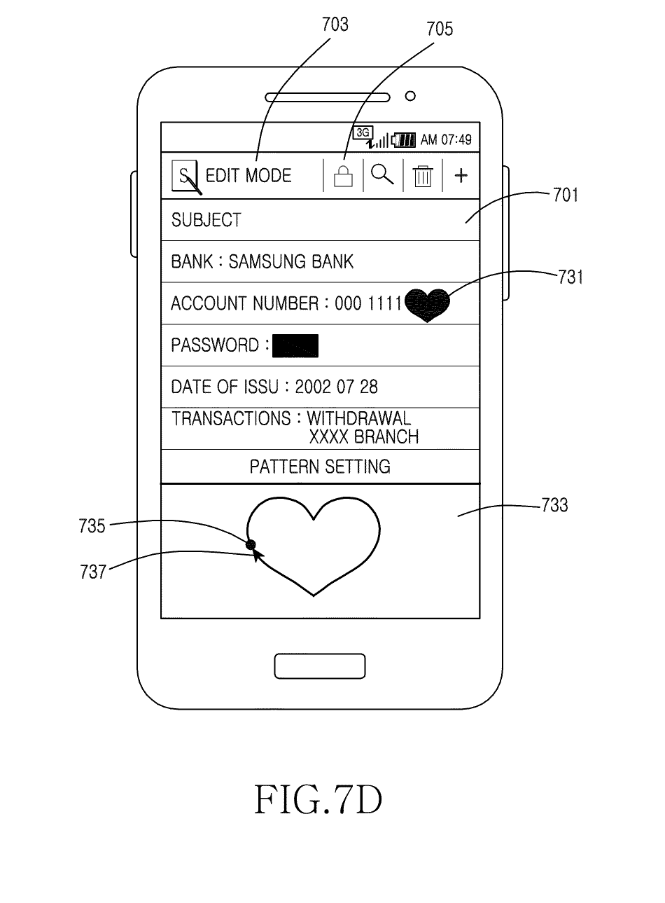

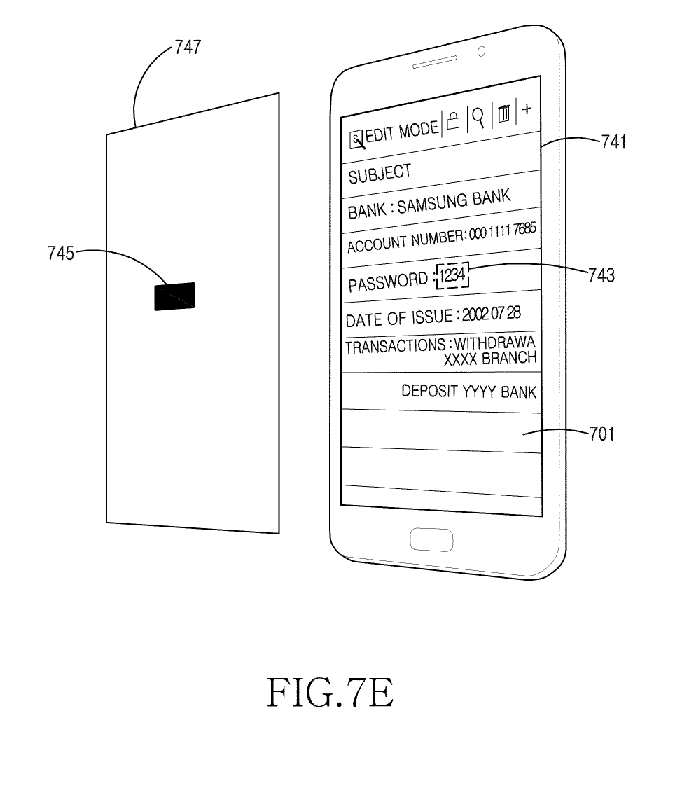

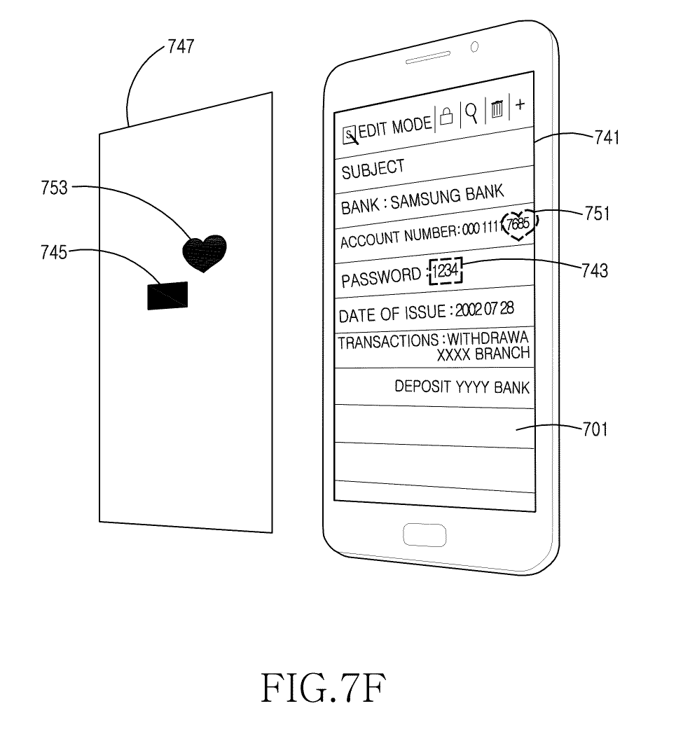

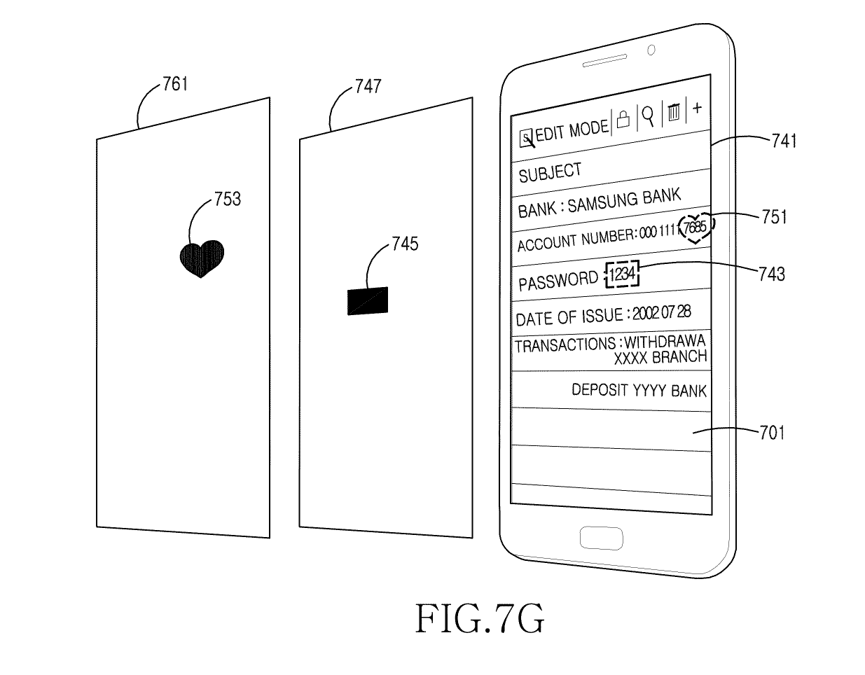

FIG. 5 is a flowchart illustrating a procedure for setting security to a partial region of contents using a password in an electronic device according to another embodiment of the present disclosure. FIGS. 7A to 7G illustrate screen configurations of setting security to a partial region of contents in an electronic device according to an embodiment of the present disclosure.

Referring to FIG. 5, in operation 501, the electronic device performs a contents edit mode. For example, as illustrated in FIG. 7A, when driving a memo application program 701, the electronic device provides an “edit mode” 703 capable of receiving an input of at least one of a character, handwriting, a diagram, a picture, an icon, a photo, and an image through the memo application program 701. Also, the electronic device may provide the “edit mode” 703 even for a previously written memo through the memo application program 701.

Next, in operation 503, the electronic device determines if a security setting event occurs. For example, when a selection of a lock “security setting icon” 705 is sensed in the memo application program 701 displayed on a display unit as illustrated in FIG. 7A, the electronic device recognizes that it sets security for a memo that is being edited. If the security setting event does not take place, the electronic device can maintain the edit mode in the memo application program 701, or terminate the algorithm of the present disclosure.

If the security setting event takes place, in operation 505, the electronic device sets a region for security setting. For example, if a block 711 is designated to a partial region of a memo in the memo application program 701 as illustrated in FIG. 7B, the electronic device recognizes the block-designated partial region as the region for security setting. At this time, the region for security setting can include at least one of a diagram, a picture, an icon, a photo, an image, and a block designated region. Also, the electronic device may input characters on the region for security setting, or locate at least one of a diagram, a picture, an icon, a photo, and an image to be superimposed on the region for security setting.

After setting the region for security setting, in operation 507, the electronic device sets a password to the region for security setting. For example, if the block 711 is designated to the partial region of the memo in the memo application program 701 as illustrated in FIG. 7B, the electronic device displays a “password setting menu” 721 as illustrated in FIG. 7C. At this time, the electronic device recognizes at least one of a character, a numeral, and a symbol entered through the “password setting menu” 721, as a password for security setting.

After setting the password, in operation 509, the electronic device stores security setting information. For example, the electronic device stores the security setting information, which includes the region for security setting having been set in operation 505 and the password having been set in operation 507, in a memory. At this time, the electronic device may encrypt and store the security setting information.

As illustrated in FIG. 7E, the electronic device can include a region for security setting 745 in a second layer 747, apart from a first layer 741 displaying the memo application program 701. At this time, the electronic device may display the region for security setting 745 included in the second layer 747 to overlap with a partial region 743 of a memo included in the first layer 741, and maintain the original content of the memo.

When the region for security setting exists in plural, as illustrated in FIG. 7F, the electronic device may include the plurality of regions for security setting 745 and 753 in the second layer 747, apart from the first layer 741 displaying the memo application program 701. At this time, the electronic device may display the regions for security setting 745 and 753 included in the second layer 747 to overlap with partial regions 743 and 751 of the memo included in the first layer 741, respectively, and maintain the original content of the memo.

When the region for security setting exists in plural, as illustrated in FIG. 7G, the electronic device may include the plurality of regions for security setting in a plurality of layers (e.g., the region for security setting 745 in the second layer 747 and the region for security setting 753 in a third layer 761), apart from the first layer 741 displaying the memo application program 701. At this time, the electronic device may display the region for security setting 745 included in the second layer 747 to overlap with the partial region 743 of the memo included in the first layer 741, and display the region for security setting 753 included in the third layer 761 to overlap with the partial region 751 of the memo included in the first layer 741, and maintain the original content of the memo.

Next, the electronic device terminates the algorithm of the present disclosure.

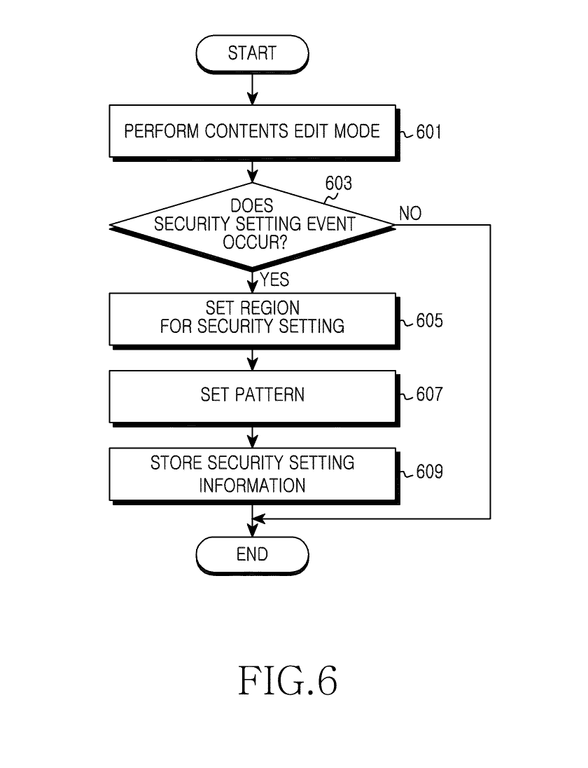

FIG. 6 is a flowchart illustrating a procedure for setting security to a partial region of contents using a pattern in an electronic device according to an embodiment of the present disclosure. FIGS. 7A to 7G illustrate screen configurations of setting security to a partial region of contents in an electronic device according to an embodiment of the present disclosure.

Referring to FIG. 6, in operation 601, the electronic device performs a contents edit mode. For example, as illustrated in FIG. 7A, when driving a memo application program 701, the electronic device provides an “edit mode” 703 capable of receiving an input of at least one of a character, handwriting, a diagram, a picture, an icon, a photo, and an image through the memo application program 701. Also, the electronic device may provide the “edit mode” 703 even for a previously written memo through the memo application program 701.

Next, in operation 603, the electronic device determines if a security setting event takes place. For example, when a selection of a “security setting icon” 705 is sensed in the memo application program 701 displayed on a display unit as illustrated in FIG. 7A, the electronic device recognizes that it sets security for a memo that is being edited. If the security setting event does not take place, the electronic device can maintain the edit mode in the memo application program 701, or terminate the algorithm of the present disclosure.

If the security setting event takes place, in operation 605, the electronic device sets a region for security setting. For example, if a block 731 is designated to a partial region of a memo in the memo application program 701 as illustrated in FIG. 7D, the electronic device recognizes the block-designated partial region as the region for security setting. At this time, the region for security setting can include at least one of a diagram, a picture, an icon, a photo, an image, and a block designated region. Also, the electronic device may input characters on the region for security setting, or locate at least one of a diagram, a picture, an icon, a photo, and an image to be superimposed on the region for security setting.

After setting the region for security setting, the electronic device sets a pattern to the region for security setting in operation 607. For example, as illustrated in FIG. 7D, if the block 731 is designated to the partial region of the memo in the memo application program 701, the electronic device displays a “pattern setting menu” 733. At this time, the electronic device recognizes a pattern drawn through the “pattern setting menu” 733 as a pattern for security setting. At this time, the electronic device recognizes the pattern using a starting point 735 and end point 737 of drawing the pattern.

After setting the pattern, the electronic device stores security setting information in operation 609. For example, the electronic device stores the security setting information, which includes the region for security setting having been set in operation 605 and the pattern having been set in operation 607, in a memory. At this time, the electronic device may encrypt and store the security setting information.

As illustrated in FIG. 7E, the electronic device can include a region for security setting 745 in a second layer 747, apart from a first layer 741 displaying the memo application program 701. At this time, the electronic device may display the region for security setting 745 included in the second layer 747 to overlap with a partial region 743 of a memo included in the first layer 741, and maintain the original content of the memo.

When the region for security setting exists in plural, as illustrated in FIG. 7F, the electronic device may include the plurality of regions for security setting 745 and 753 in the second layer 747, apart from the first layer 741 displaying the memo application program 701. At this time, the electronic device may display the regions for security setting 745 and 753 included in the second layer 747 to overlap with partial regions 743 and 751 of the memo included in the first layer 741, respectively, and maintain the original content of the memo.

When the region for security setting exists in plural, as illustrated in FIG. 7G, the electronic device may include the plurality of regions for security setting in a plurality of layers (e.g., the second layer 747 and a third layer 761), apart from the first layer 741 displaying the memo application program 701. At this time, the electronic device may display the region for security setting 745 included in the second layer 747 to overlap with the partial region 743 of the memo included in the first layer 741, and display the region for security setting 753 included in the third layer 761 to overlap with the partial region 751 of the memo included in the first layer 741, and maintain the original content of the memo.

After that, the electronic device terminates the algorithm of the present disclosure.

In the aforementioned embodiment, when a security setting event occurs, the electronic device sets a region for security setting.

In another embodiment, after setting the region for security setting, the electronic device may determine whether the security setting event occurs.

Also, in the aforementioned embodiment, after setting the region for security setting, the electronic device sets at least one of a password and pattern for security setting.

In another embodiment, the electronic device may set a pattern for security setting using a starting point and end point of the pattern for setting the region for security setting.

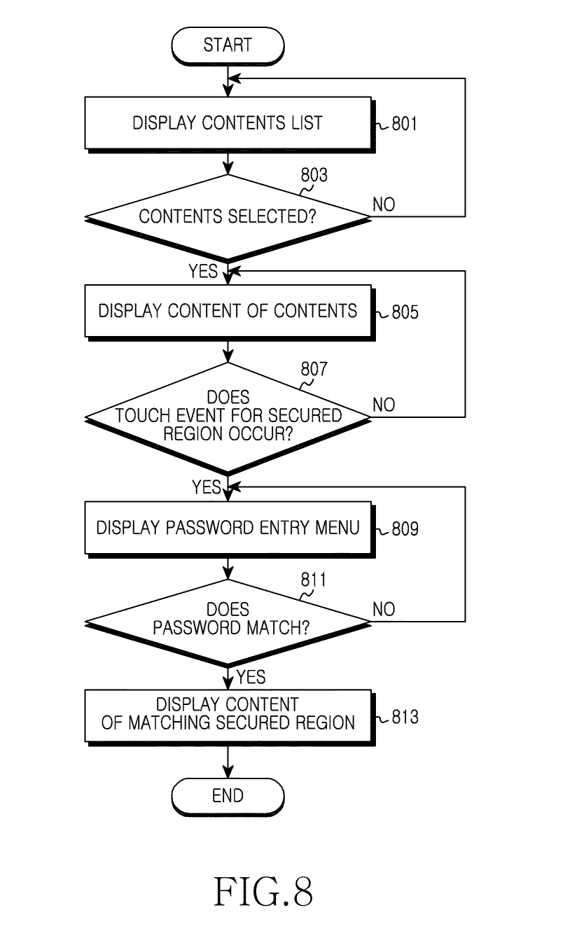

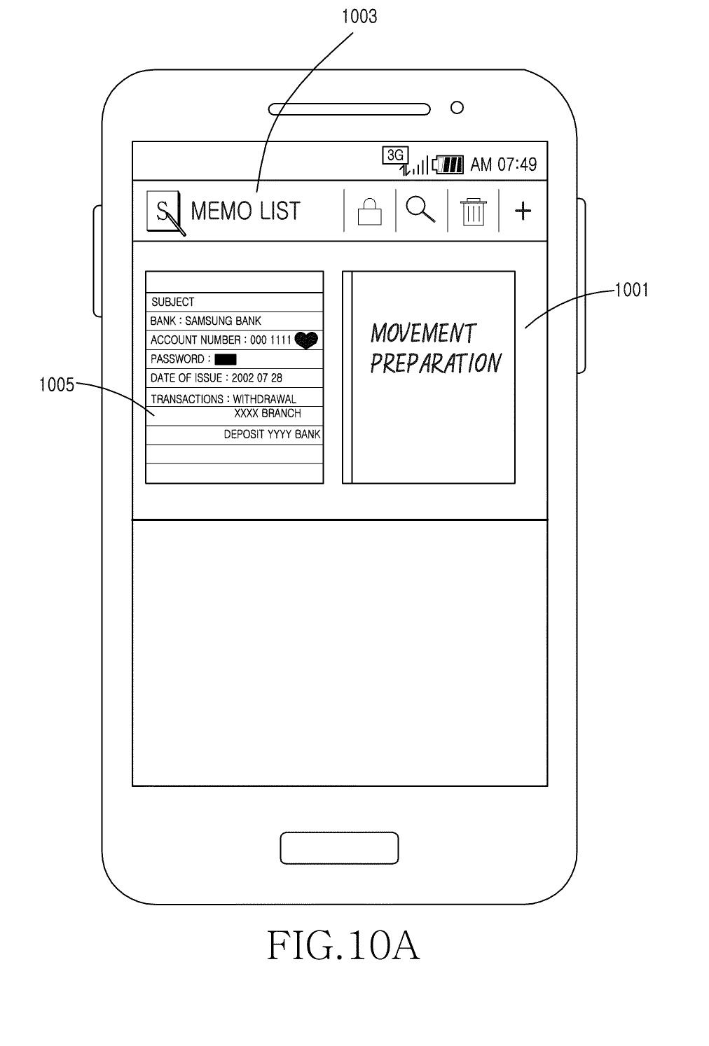

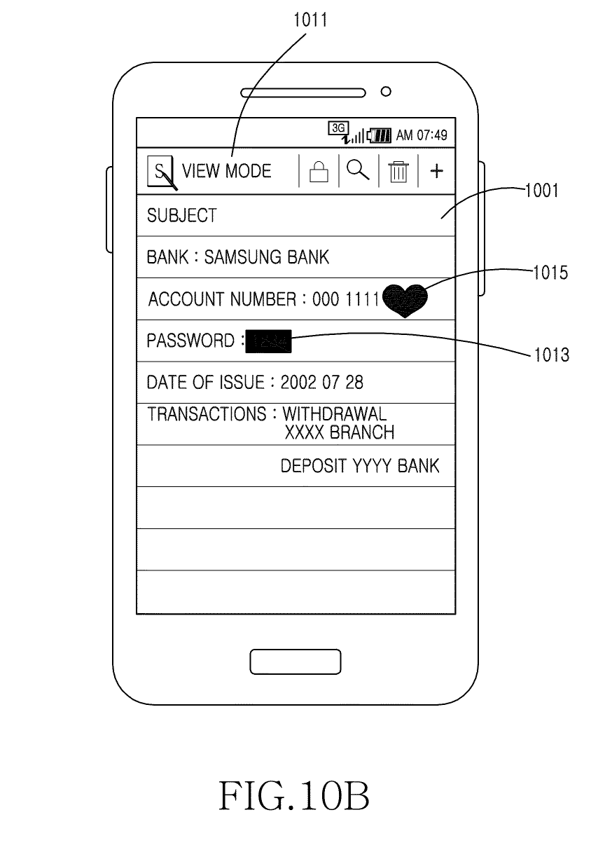

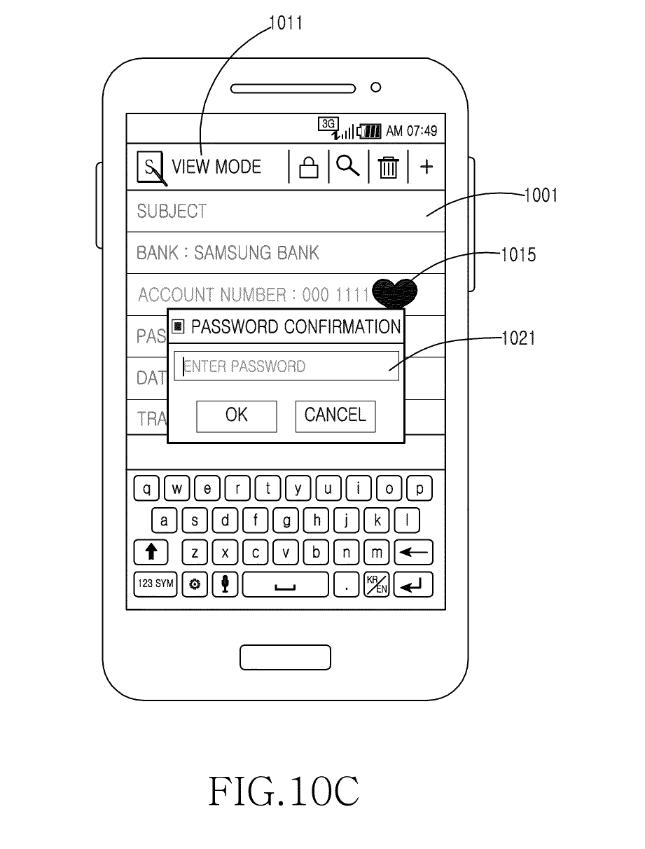

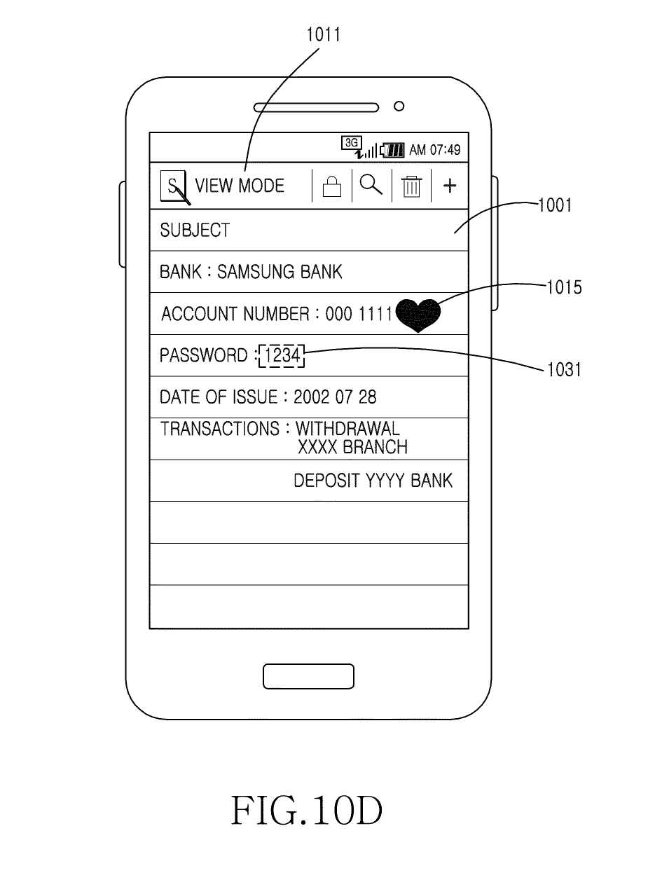

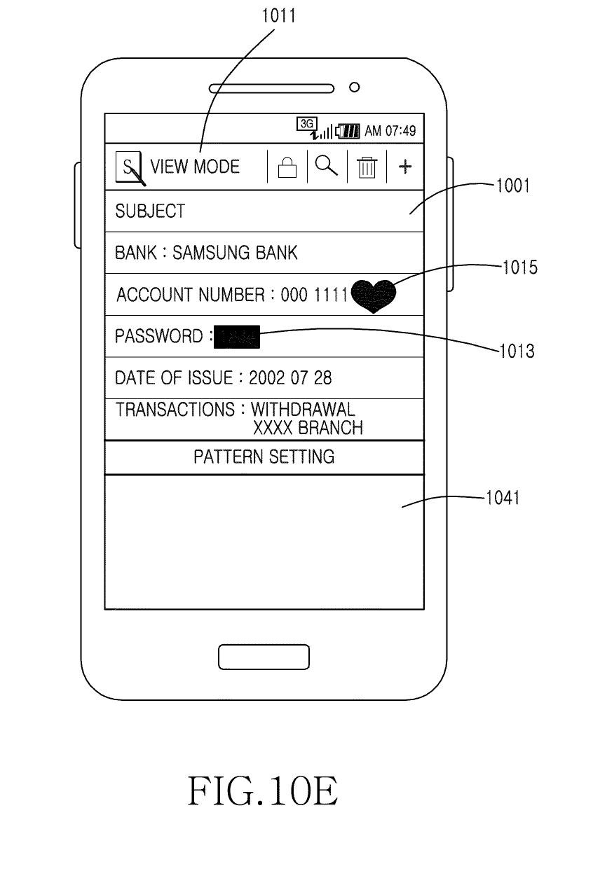

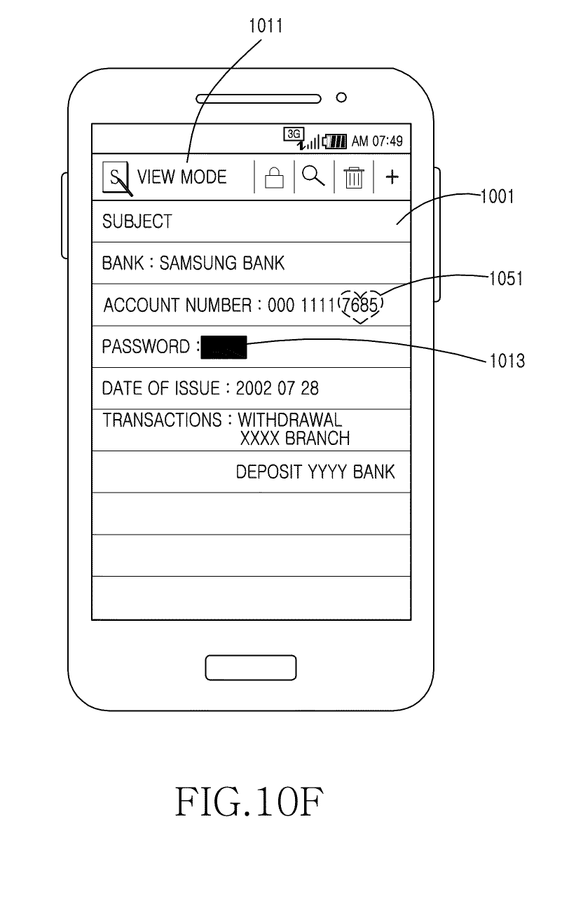

FIG. 8 is a flowchart illustrating a procedure for providing contents for which security is set to a partial region of the contents by a password in an electronic device according to another embodiment of the present disclosure. FIGS. 10A, 10B, 10C, 10D, 10E, and 10F illustrate screen configurations of providing contents for which security is set to a partial region of the contents in an electronic device according to an embodiment of the present disclosure.

Referring to FIG. 8, in operation 801, the electronic device displays a contents list. For example, when driving a memo list 1003 in a memo application program 1001 as illustrated in FIG. 10A, the electronic device displays on a display unit at least one memo which is written through the memo application program 1001, or which is written in a different application program but whose edit and view are available through the memo application program 1001. At this time, the electronic device may display a preview of the at least one memo among the “memo list” 1003. At this time, if security is set to a partial region among the content of the at least one memo, the electronic device may display a preview of the content of the at least one memo excepting the partial region to which security is set.

After displaying the contents list, the electronic device determines if contents are selected from the contents list in operation 803. For example, as illustrated in FIG. 10A, the electronic device determines if at least one memo is selected from the “memo list” 1003 displayed on the display unit. If the contents are not selected, the electronic device keeps displaying the contents list in operation 801.

If the contents are selected, the electronic device displays the content of the selected contents in operation 805. For example, if a selection of a memo 1005 from the “memo list” 1003 displayed on the display unit is sensed as illustrated in FIG. 10A, the electronic device displays on the display unit the selected memo 1005 using a “view mode” 1011 of the memo application program 1001 as illustrated in FIG. 10B. In an embodiment, the electronic device may display at least one secured region 1013 or 1015 included in the memo 1005. Here, the secured region can include at least one of a diagram, a picture, an icon, a photo, an image, and a block designated region. Also, at least one of a character, a diagram, a picture, an icon, a photo, and an image may be located to be superimposed on the secured region. At this time, when setting a title of the memo, the electronic device may display the title of the memo at an upper end of the display unit.

After that, in operation 807, the electronic device determines if a touch event for a secured region takes place. For example, as illustrated in FIG. 10B, the electronic device determines if a selection of the at least one secured region 1013 or 1015 is sensed. If the touch event for the secured region does not take place, in operation 805, the electronic device keeps displaying the content of the contents.

Meantime, if the touch event for the secured region takes place, the electronic device displays a password entry menu in operation 809. For example, if the selection of the first secured region 1013 is sensed as illustrated in FIG. 10B, the electronic device displays a “password confirmation menu” 1021 on the display unit as illustrated in FIG. 10C.

After displaying the password entry menu, the electronic device determines if a password entered through the password entry menu matches with a password previously set to the secured region in operation 811. For example, as illustrated in FIG. 10C, the electronic device determines if an entered password matches with a password previously set to the first secured region 1013 using at least one of a character, a numeral, and a symbol entered through the “password confirmation menu” 1021 displayed on the display unit. If the entered password does not match with the password previously set to the secured region, the electronic device keeps displaying the password entry menu in operation 809.

Meantime, if the entered password matches with the password previously set to the secured region, the electronic device displays the content of the matching secured region in operation 813. For example, if the password entered through the “password confirmation menu” 1021 matches with the password previously set to the first secured region 1013 as illustrated in FIG. 10C, the electronic device displays on the display unit the content 1031 of the first secured region 1013 as illustrated in FIG. 10D.

Next, the electronic device terminates the algorithm of the present disclosure.

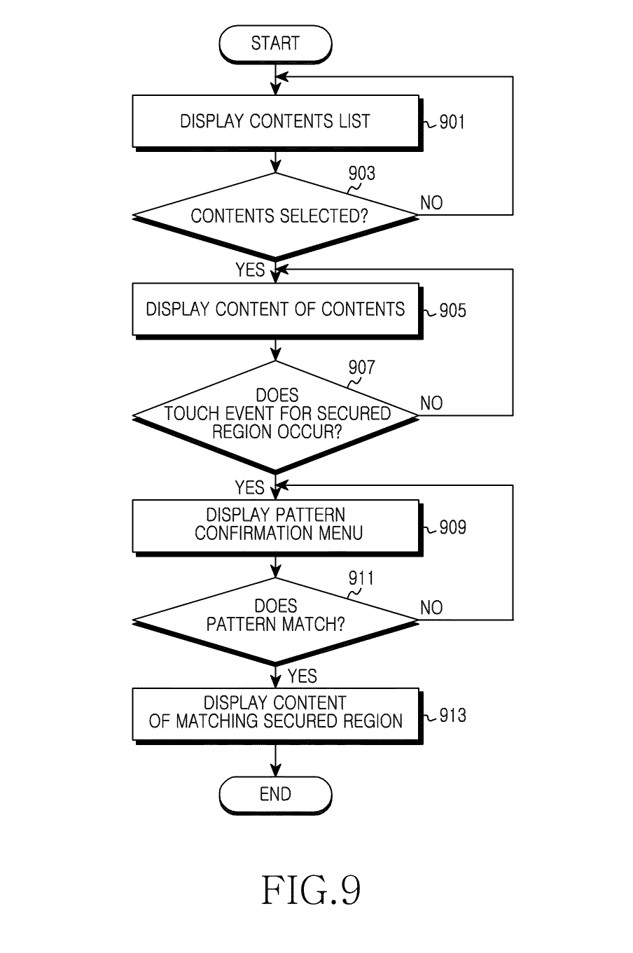

FIG. 9 is a flowchart illustrating a procedure for providing contents to which security is set to a partial region of the contents by a pattern in an electronic device according to still another embodiment of the present disclosure. FIGS. 10A to 10F illustrate screen configurations of providing contents for which security is set to a partial region of the contents in an electronic device according to an embodiment of the present disclosure.

Referring to FIG. 9, in operation 901, the electronic device displays a contents list. For example, when driving a memo list 1003 in a memo application program 1001 as illustrated in FIG. 10A, the electronic device displays on a display unit at least one memo which is written through the memo application program 1001, or which is written in a different application program but whose edit and view are available through the memo application program 1001. At this time, the electronic device may display a preview of the at least one memo among the “memo list” 1003. At this time, if security is set to a partial region among the content of the at least one memo, the electronic device may display a preview of the content of the at least one memo excepting the partial region to which security is set.

After displaying the contents list, the electronic device determines if contents are selected from the contents list in operation 903. For example, as illustrated in FIG. 10A, the electronic device determines if at least one memo is selected from the “memo list” 1003 displayed on the display unit. If the contents are not selected, the electronic device keeps displaying the contents list in operation 901.

If the contents are selected, the electronic device displays the content of the selected contents in operation 905. For example, if a selection of a memo 1005 from the “memo list” 1003 displayed on the display unit is sensed as illustrated in FIG. 10A, the electronic device displays on the display unit the selected memo 1005 using a “view mode” 1011 of the memo application program 1001 as illustrated in FIG. 10B. In an embodiment, the electronic device may display at least one secured region 1013 or 1015 included in the memo 1005. Here, the secured region can include at least one of a diagram, a picture, an icon, a photo, an image, and a block designated region. Also, at least one of a character, a diagram, a picture, an icon, a photo, and an image may be located to be superimposed on the secured region. At this time, when setting a title of the memo, the electronic device may display the title of the memo at an upper end of the display unit.

After that, the electronic device determines if a touch event for a secured region takes place in operation 907. For example, as illustrated in FIG. 10B, the electronic device determines if a selection of the at least one secured region 1013 or 1015 is sensed. If the touch event for the secured region does not take place, the electronic device keeps displaying the content of the contents in operation 905.

If the touch event for the secured region takes place, the electronic device displays a pattern confirmation menu in operation 909. For example, if the selection of the second secured region 1015 is sensed as illustrated in FIG. 10B, the electronic device displays a “pattern confirmation menu” 1041 on the display unit as illustrated in FIG. 10E.

After displaying the pattern confirmation menu, the electronic device determines if a pattern input through the pattern confirmation menu matches with a pattern previously set to the secured region in operation 911. For example, if a pattern is input through the “pattern confirmation menu 1041 displayed on the display unit as illustrated in FIG. 10E, the electronic device recognizes the input pattern as a pattern for attempting security cancelation for the second secured region 1015. According to this, the electronic device determines if the pattern input through the “pattern confirmation menu” 1041 matches with a pattern previously set to the second secured region 1015. At this time, the electronic device may determine if the pattern matches with the pattern previously set to the secured region using a starting point and end point of drawing the pattern. If the input pattern does not match with the pattern previously set to the secured region, the electronic device keeps displaying the pattern confirmation menu in operation 909.

Meantime, if the input pattern matches with the pattern previously set to the secured region, the electronic device displays the content of the matching secured region in operation 913. For example, if the pattern input through the “pattern confirmation menu” 1041 matches with the pattern previously set to the second secured region 1015 as illustrated in FIG. 10E, the electronic device displays on the display unit the content 1051 of the second secured region 1015 as illustrated in FIG. 10F.

Next, the electronic device terminates the algorithm of the present disclosure.

Additionally, a master password or master pattern capable of concurrently canceling security setting from a plurality of secured regions included in contents in an electronic device may exist.

The electronic device and methods described herein may be realized by a computer-readable code in a non-transitory computer-readable recording medium. The non-transitory computer-readable recording medium includes all types of recording devices which store data readable by a computer system. Examples of the recording medium include a Read-Only Memory (ROM), a Random Access Memory (RAM), an optical disk, a magnetic tape, a floppy disk, a hard disk, a nonvolatile memory, etc. Further, the non-transitory computer-readable recording medium may be dispersed in computer systems connected through a network, and a computer-readable code may be stored and executed in a dispersion scheme.

As described above, various embodiments of the present disclosure provide an advantage in which, because setting security to a partial region of contents, an electronic device user does not need to perform the security cancelation of the contents when confirming the content of a region to which security is not set in the contents in an electronic device. That is, the various embodiments of the present disclosure provide an advantage of decreasing a possibility of a leakage of secured information, because the electronic device user performs the security cancelation of the contents only when confirming the content of a region to which security is set in the contents.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling contents security in an electronic device, the method comprising:
determining at least one region for security setting in contents; and
setting security to the region for security setting,
wherein the contents comprise at least one of a document, a memo, an image, an instant message, an electronic mail (e-mail), a Short Message Service (SMS) message, and a Multimedia Message Service (MMS) message.

2. The method of claim 1, wherein the determining of the region for security setting comprises using at least one of a diagram, a picture, an icon, a photo, an image, and a block designation for a partial region of the contents.

3. The method of claim 1, wherein the determining of the region for security setting comprises generating at least one second layer displaying the at least one region for security setting, apart from a first layer displaying original content of the contents.

4. The method of claim 1, further comprising locating to superimpose at least one of a diagram, a picture, an icon, a photo, and an image on the at least one region for security setting.

5. The method of claim 1, wherein the setting of the security to the region for security setting comprises:
displaying a password setting menu; and
setting the security to the region for security setting using at least one of a character, a numeral, and a symbol entered through the password setting menu.

6. The method of claim 1, wherein the security is set independently to each of the at least one region for security setting.

7. A method for controlling contents security in an electronic device, the method comprising:
displaying contents comprising at least one secured region;
if a selection of the secured region is sensed, determining a security cancelation or non-cancelation of the secured region; and
if the security of the secured region is canceled, displaying original content of the contents for the canceled secured region.

8. The method of claim 7, wherein the determining of the security cancelation or non-cancelation comprises:
displaying a password confirmation menu; and
determining matching or non-matching with a password previously set to the secured region using at least one of a character, a numeral, and a symbol entered through the password confirmation menu.

9. The method of claim 7, wherein the security is set independently to each of the at least one secured region.

10. An electronic device comprising:
at least one memory configured to store data and instructions; and
at least one processor configured to determine at least one region for security setting in contents, and to set security to the region for security setting,
wherein the contents comprise at least one of a document, a memo, an image, an instant message, an electronic mail (e-mail), a Short Message Service (SMS) message, and a Multimedia Message Service (MMS) message.

11. The electronic device of claim 10, wherein the processor determines the region for security setting using at least one of a diagram, a picture, an icon, a photo, an image, and a block designation for a partial region of the contents.

12. The electronic device of claim 10, wherein the processor generates at least one second layer for displaying the at least one region for security setting, apart from a first layer displaying original content of the contents.

13. The electronic device of claim 10, wherein the processor inputs characters on the at least one region for security setting.

14. The electronic device of claim 10, wherein the processor locates to superimpose at least one of a diagram, a picture, an icon, a photo, and an image on the at least one region for security setting.

15. The electronic device of claim 10, wherein the processor displays a pattern setting menu, and sets the security to the region for security setting using a pattern input through the pattern setting menu.

16. The electronic device of claim 15, wherein the input pattern is determined according to a starting point and an ending point.

17. The electronic device of claim 10, wherein the processor stores information about the secured region and the security set to the secured region.

18. The electronic device of claim 10, wherein the security is set independently to each of the at least one region for security setting.

19. An electronic device comprising:
at least one memory configured to store data and instructions; and
at least one processor configured to control to display contents comprising at least one secured region and, if a selection of the secured region is sensed, to determine security cancelation or non-cancelation of the secured region and, if the security of the secured region is canceled, to display original content of the contents for the canceled secured region.

20. The electronic device of claim 19, wherein, if the selection of the secured region is sensed, the processor displays a password confirmation menu, and determines matching or non-matching with a password previously set to the secured region using at least one of a character, a numeral, and a symbol entered through the password confirmation menu.
